(19) United States
(12) Patent Application Publication
(10) Pub. No.: US 2014/0297263 A1
(43) Pub. Date: Oct. 2, 2014

(54) METHOD AND APPARATUS FOR VERIFYING TRANSLATION USING ANIMATION

(71) Applicant: Electronics and Telecommunications Research Institute, Daejeon (KR)

(72) Inventors: Chang Hyun KIM, Daejeon (KR); Young Kil KIM, Daejeon (KR); Oh Woog KWON, Daejeon (KR); Seung-Hoon NA, Daejeon (KR); Yoon-Hyung ROH, Daejeon (KR); Young-Ae SEO, Daejeon (KR); SEONG IL YANG, Daejeon (KR); Ki Young LEE, Daejeon (KR); Sang Keun JUNG, Daejeon (KR); Sung Kwon CHOI, Daejeon (KR); Yun JIN, Daejeon (KR); Eun Jin PARK, Daejeon (KR); Jong Hun SHIN, Daejeon (KR); Jinxia HUANG, Daejeon (KR); Sang Kyu PARK, Daejeon (KR)

(21) Appl. No.: 13/922,399

(22) Filed: Jun. 20, 2013

(30) Foreign Application Priority Data
Mar. 27, 2013 (KR) 10-2013-0032522

(51) Int. Cl. G06F 17/28; G06T 13/00

(52) U.S. Cl. CPC G06F 17/2881; G06T 13/00
USPC 704/9

(57) ABSTRACT

A translation verification method using an animation may include the processes of analyzing an originally input sentence in a first language using a translation engine so that the sentence in the first language is converted into a second language, generating an animation capable of representing the meaning of the sentence in the first language based on information on the results of the analysis of the sentence in the first language, and providing the original and the generated animation to a user who uses the original in order for the user to check for errors in the translation.

### RELATED APPLICATIONS(S)

This application claims the benefit of Korean Patent Application No. 10-2013-0032522, filed on Mar. 27, 2013, which is hereby incorporated by references as if fully set forth herein.

### FIELD OF THE INVENTION

The present invention relates to a scheme for verifying automatic translation and, more particularly, to a method and apparatus for verifying translation using an animation, wherein a user who uses a first language can verify the accuracy of the results of the translation of a sentence in real time in a unidirectional automatic translation situation, in which the first language is translated into a second language, or a user who uses a first language and a user who uses a second language can verify the accuracy of the results of the translation of sentences at the same time in a bidirectional automatic translation situation, in which bidirectional translation is performed between the first language and the second language.

### BACKGROUND OF THE INVENTION

Conventional automatic translation apparatuses can be classified into a unidirectional automatic translation apparatus, in which an automatic translation apparatus for translating a native language into a foreign language and an automatic translation apparatus for translating a foreign language into a native language are independently operated, and a bidirectional automatic translation apparatus, in which translation between a native language and a foreign language is performed bidirectionally for communication with a foreigner, depending on the type of use.

A situation that is frequently encountered in translation using the unidirectional and bidirectional automatic translation apparatus is that a user who requests automatic translation does not know a counterpart's language. Accordingly, there is a problem in that it is difficult for a user to check whether or not automatic translation results are correct.

In order to solve this problem, the existing automatic translation apparatus is equipped with an apparatus for providing back translation in order to provide reliable translation results. Back translation means that a foreign language, that is, automatic translation results, is translated back into a native language.

If the results of back translation are provided to a user, a user who uses a native language can compare the original to be translated with the back-translated sentence and check whether or not automatic translation is correct using only the native language, based on the result of the comparison. That is, a user can check automatic translation results through results, such as the following examples (i.e., the original, the results of translation, and the results of back translation).

The original: [symbol] [symbol] .

Translation results: I like a pear.

Back translation results: [symbol] [symbol] .

That is, a user who uses the original can verify that the sentence to be translated has been correctly translated by checking the results of the back translation. However, this back translation function cannot be used alone to check with certainty whether or not translation has been correctly performed.

First, in a bidirectional automatic translation environment, back translation results can be provided because a native language can be translated into a foreign language and a foreign language can be translated into a native language. In a unidirectional automatic translation environment, however, back translation is impossible because a native language can only be translated into a foreign language.

Second, the following errors may occur in a back translation process even if the original is correctly translated.

The original: He requested an apology.

Translation results: [symbol] [symbol] .

Back translation results: He requested an apple.

That is, the original has been correctly translated, but the back translation results of the translation may be quite different from the original. In this case, the user determines that the automatic translation results are incorrect.

Third, even if the original is erroneously translated, the erroneous translation may be interpreted as having the same meaning as that of the original in a back translation process.

The original: [symbol] [symbol] .

A translated sentence: I bought a tree and peeled a pear.

Back translation results: [symbol] [symbol] .

Accordingly, there is an urgent need for a new scheme capable of overcoming the problem with the verification of the accuracy of automatic translation using back translation as described above.

### SUMMARY OF THE INVENTION

In view of the above, the present invention provides a new scheme capable of solving problems when verifying translation errors that may occur in automatic translation by generating an animation capable of representing the meaning of a sentence in a first language based on the results of an analysis of the sentence in the first language (i.e., the original) and providing the generated animation and the original to a user who uses the first language (i.e., the original) and/or generating an animation capable of representing the meaning of a sentence in a first language based on the results of an analysis of the sentence in the first language and providing the generated animation and a sentence in a second language to a user who uses the second language (i.e., a translated sentence) in order to verify the accuracy of the results of translation in a unidirectional or bidirectional automatic interpretation and translation environment.

In accordance with a first aspect of the present invention, there is provided a translation verification method using an animation, including the processes of analyzing an originally input sentence in a first language using a translation engine so that the sentence in the first language is converted into a second language, generating an animation capable of representing the meaning of the sentence in the first language based on information on the results of the analysis of the sentence in the first language, and providing the original and the generated animation to a user who uses the original in order for the user to check for errors in the translation.

In the present invention, the information on the results of the analysis may include one or more of information on the results of a morpheme analysis of the sentence in the first language, information on the results of an analysis of the structure of the sentence in the first language, information on the results of an analysis of the meaning of the sentence in the first language, and information on the conversion into the second language.

In the present invention, the process of analyzing a sentence in a first language may include the processes of receiving the original and generating the sentence in the first language, performing a morpheme analysis of the generated sentence in the first language, performing a sentence structure analysis of each word based on information on a part of speech whose morpheme has been analyzed, performing a meaning analysis of each word based on the results of the sentence structure analysis, and converting the sentence in the first language into the second language based on the results of the meaning analysis.

In the present invention, the process of analyzing a sentence in a first language may include the processes of receiving the original and generating the sentence in the first language, performing a morpheme analysis of the generated sentence in the first language, and converting the sentence in the first language into the second language based on the results of the morpheme analysis.

In accordance with a second aspect of the present invention, there is provided a translation verification apparatus using an animation, including a translation engine block for analyzing an originally input sentence in a first language so that the sentence in the first language is converted into a second language, an animation generation block for generating an animation capable of representing the meaning of the sentence in the first language based on information on the results of the analysis of the sentence in the first language, and an interface block for providing the original and the generated animation to a user who uses the original in order for the user to check for errors in the translation.

In the present invention, the animation generation block may generate the animation using one or more of information on the results of a morpheme analysis of the sentence in the first language, information on the results of a sentence structure analysis of the sentence in the first language, information on the results of a meaning analysis of the sentence in the first language, and information on the conversion into the second language.

In the present invention, the translation engine block may include an original recognition unit for receiving the original and generating the sentence in the first language, a morpheme analysis unit for performing a morpheme analysis of the generated sentence in the first language, a sentence structure analysis unit for performing a sentence structure analysis of each word based on information on a part of speech whose morpheme has been analyzed, a meaning analysis unit for performing a meaning analysis of each word based on the results of the sentence structure analysis, and a language conversion unit for converting the sentence in the first language into the second language based on the results of the meaning analysis.

In the present invention, the translation engine block may include an original recognition unit for receiving the original and generating the sentence in the first language, a morpheme analysis unit for performing a morpheme analysis of the generated sentence in the first language, and a language conversion unit for converting the sentence in the first language into the second language based on the results of the morpheme analysis.

In accordance with a third aspect of the present invention, there is provided a translation verification method using an animation, including the processes of analyzing an originally input sentence in a first language using a translation engine so that the sentence in the first language is converted into a second language, generating an animation capable of representing the meaning of the sentence in the first language based on information on the results of the analysis of the sentence in the first language, and providing a sentence in a second language and an animation generated by analyzing the sentence in the first language to a user who uses the sentence in the second language in order for the user to check for errors in the translation.

In the present invention, the information on the results of the analysis may include one or more of information on the results of a morpheme analysis of the sentence in the first language, information on the results of a sentence structure analysis of the sentence in the first language, information on the results of a meaning analysis of the sentence in the first language, and information on the conversion into the second language.

In the present invention, the process of analyzing a sentence in a first language may include the processes of receiving the original and generating the sentence in the first language, performing a morpheme analysis of the generated sentence in the first language, performing a sentence structure analysis of each word based on information on a part of speech whose morpheme has been analyzed, performing a meaning analysis of each word based on the results of the sentence structure analysis, and converting the sentence in the first language into the second language based on the results of the meaning analysis.

In the present invention, the process of analyzing a sentence in a first language may include the processes of receiving the original and generating the sentence in the first language, performing a morpheme analysis of the generated sentence in the first language, and converting the sentence in the first language into the second language based on the results of the morpheme analysis.

In the present invention, the sentence in the second language may include second language voice and text corresponding to the sentence in the second language.

### BRIEF DESCRIPTION OF THE DRAWINGS

The objects and features of the present invention will become apparent from the following description of embodiments given in conjunction with the accompanying drawings, in which:

FIG. 1 is a block diagram showing the construction of a translation verification apparatus using an animation in accordance with an embodiment of the present invention;

FIG. 2 is a flowchart illustrating major processes for performing translation verification using an animation in accordance with an embodiment of the present invention;

FIG. 3 is a block diagram showing the construction of a translation verification apparatus using an animation in accordance with another embodiment of the present invention;

FIG. 4 is a flowchart illustrating major processes for performing translation verification using an animation in accordance with another embodiment of the present invention;

FIGS. 5a to 5d are exemplary diagrams showing the results of an analysis of the original in accordance with an embodiment of the present invention;

FIGS. 6a and 6b are exemplary diagrams of animations generated using the respective results of the analysis of FIG. 5;

FIGS. 7a to 7d are exemplary diagrams showing the results of an analysis of the original in accordance with an embodiment of the present invention; and

FIGS. 8a and 8b and FIGS. 9a and 9b are exemplary diagrams of animations generated using the respective results of the analysis of FIG. 7.

### DETAILED DESCRIPTION OF THE EMBODIMENTS

Hereinafter, embodiments of the present invention will be described in detail with reference to the accompanying drawings, which form a part hereof.

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

Furthermore, in describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

### Embodiment 1

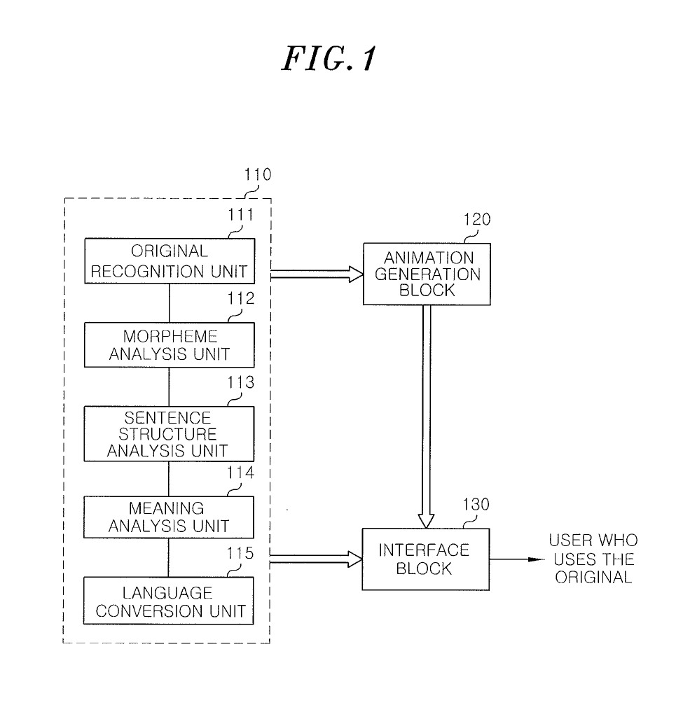

FIG. 1 is a block diagram showing the construction of a translation verification apparatus using an animation in accordance with an embodiment of the present invention. The translation verification apparatus of the present embodiment basically includes a translation engine block 110, an animation generation block 120, and an interface block 130. The translation engine block 110 includes an original recognition unit 111, a morpheme analysis unit 112, a sentence structure analysis unit 113, a meaning analysis unit 114, and a language conversion unit 115.

First, the translation engine block 110 performs a function of analyzing the sentence in the first language of the received original (voice or text) into a sentence in a second language. To this end, the original recognition unit 111 can perform a function of receiving the original (i.e., a first language) that is provided in voice or text from a user who uses the original (i.e., a first user), generating a sentence in a first language using the received original, and transferring the generated sentence in the first language to the morpheme analysis unit 112. Here, the sentence in the first language of the recognized original can be transferred to the interface block 130 so that it can be used to check for errors in translation.

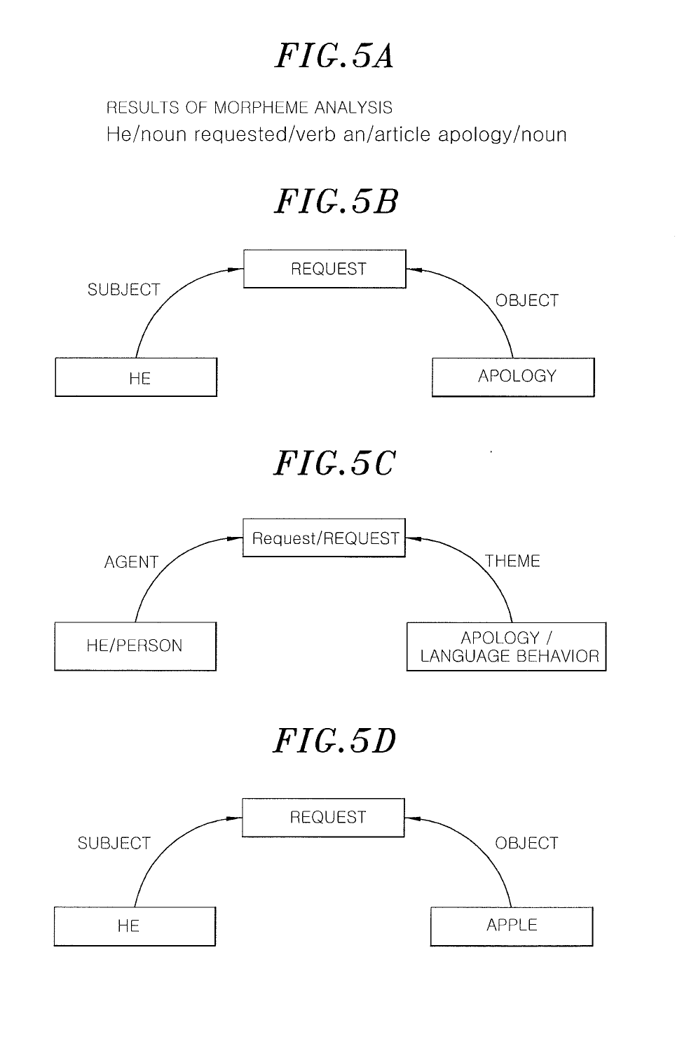

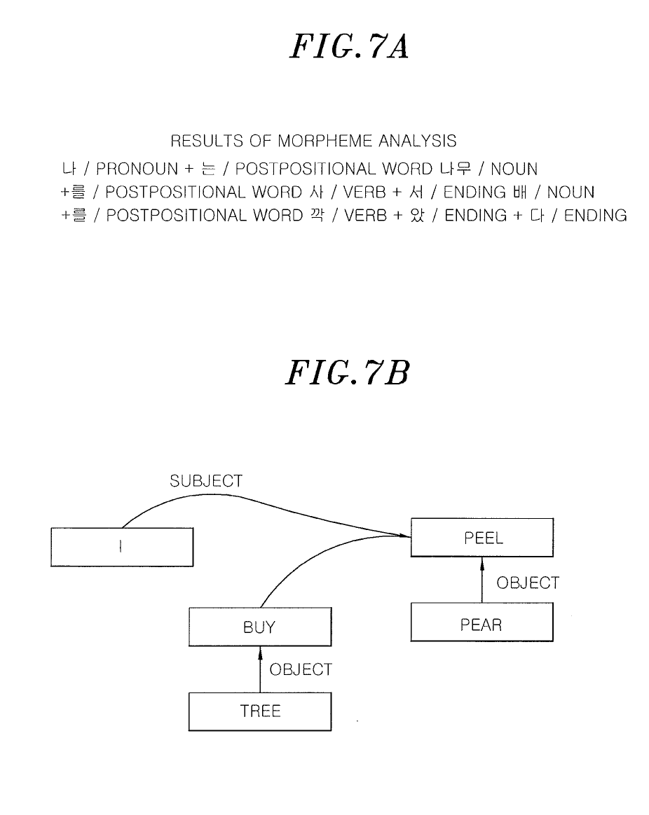

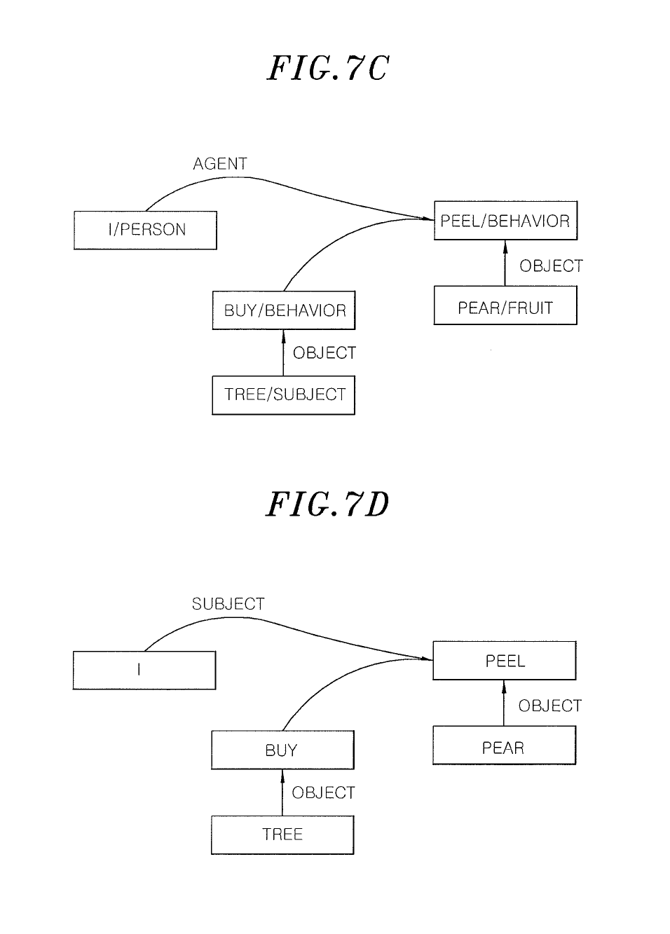

The morpheme analysis unit 112 can perform a function of performing a morpheme analysis of the sentence in the first language generated by the original recognition unit 111. The sentence structure analysis unit 113 can perform a function of performing a sentence structure analysis of each word based on information on a part of speech whose morphemes have been analyzed by the morpheme analysis unit 112. The results of the morpheme analysis and the results of the sentence structure analysis of the sentence in the first language can be transferred to the animation generation block 120. Furthermore, the results of the morpheme analysis of the sentence in the first language can be, for example, the same as results such as those shown in FIGS. 5a and 7a. The results of the sentence structure analysis of the sentence in the first language whose morphemes have been analyzed can be, for example, the same as results such as those shown in FIGS. 5b and 7b.

The meaning analysis unit 114 can perform a function of performing an analysis of the meaning of each word based on the results of the sentence structure analysis provided by the sentence structure analysis unit 113. The language conversion unit 115 can perform a function of converting the sentence in the first language (e.g., a native language) into a second language (e.g., a foreign language) based on the results of the meaning analysis provided by the meaning analysis unit 114. Here, the results of the meaning analysis of the sentence in the first language and information on the conversion into the second language can be transferred to the animation generation block 120. Furthermore, the results of the meaning analysis of the sentence in the first language whose sentence structure has been analyzed can be arranged, for example, as shown in FIGS. 5c and 7c. The results of the conversion from the sentence in the first language whose meaning has been analyzed into the second language can be arranged, for example, as shown in FIGS. 5d and 7d.

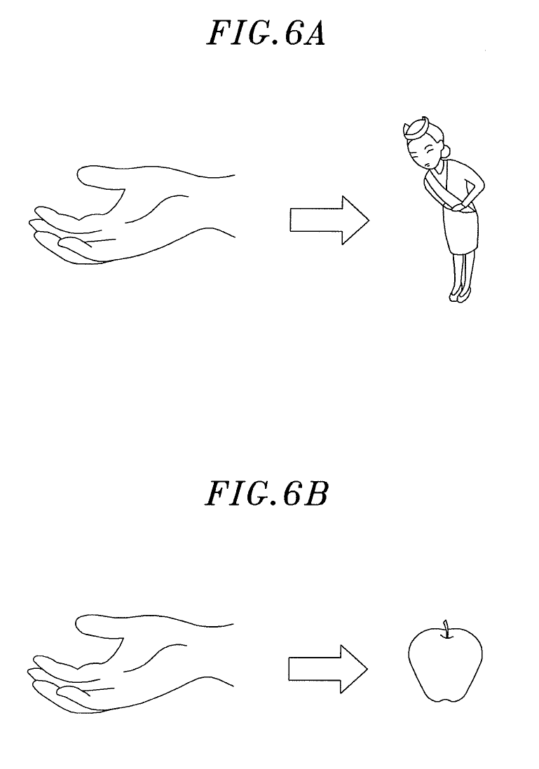

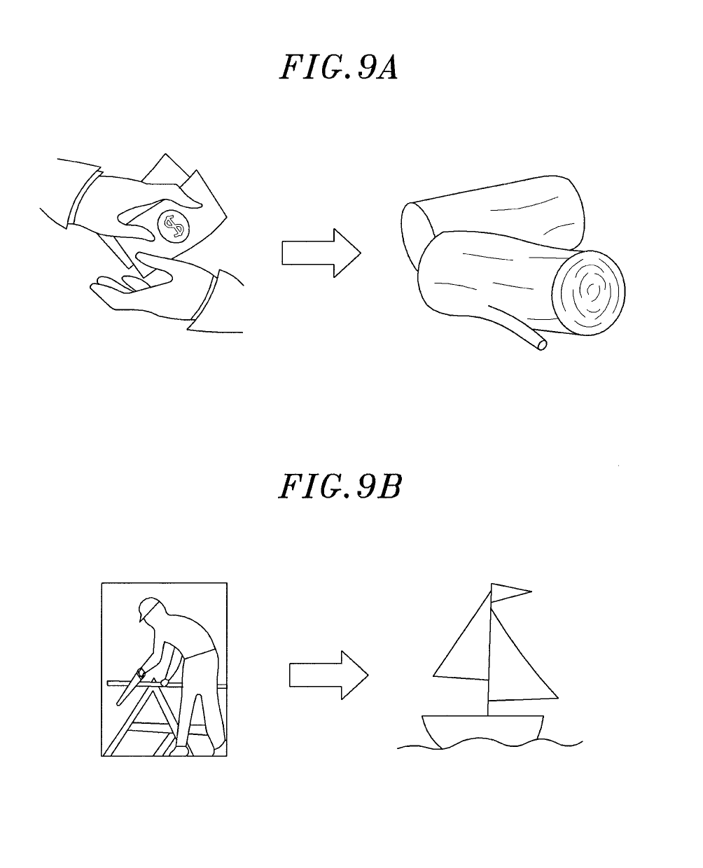

Furthermore, the animation generation block 120 can perform a function of generating animations (e.g., animations shown FIGS. 6a, 9a, and 9b) capable of representing the meaning of the sentence in the first language (i.e., a translated language) using the information on the results of the analysis of the sentence in the first language (i.e., the original) and transferring the animations to the interface block 130. For example, the animation generation block 120 can generate the animations on the basis of at least one of information on the results of the morpheme analysis of the sentence in the first language that are provided by the morpheme analysis unit 112, information on the results of the sentence structure analysis of the sentence in the first language that are provided by the sentence structure analysis unit 113, information on the results of the meaning analysis of the sentence in the first language that are provided by the meaning analysis unit 114, and information on the conversion into the second language that is provided by the language conversion unit 115. The generated animation means results obtained by converting information on a language into information on an image. The generated animation may be any of, for example, a moving image, a plurality of serial still images, and one still image.

The interface block 130 can perform a function of gathering (or composing) the original (i.e., the sentence in the first language) provided by the translation engine block 110 and the animation (i.e., an animation capable of representing the meaning of the sentence in the first language) provided by the animation generation block 120 and transferring the gathered results to the user who uses the original (e.g., the terminal of the user who uses the original) so that the user who uses the original can check for errors in translation.

Meanwhile, in the translation verification apparatus of the present embodiment, the translation engine block 110 has been illustrated as including the original recognition unit 111, the morpheme analysis unit 112, the sentence structure analysis unit 113, the meaning analysis unit 114, and the language conversion unit 115, but the invention of the present embodiment is not limited thereto. The translation engine block 110 applied to the present embodiment may be configured to include only the original recognition unit 111, the morpheme analysis unit 112, and the language conversion unit 115, depending on the translation method.

A series of processes for performing translation verification using an animation generated using the results of an analysis of the original is described in detail below in connection with the translation verification apparatus of the present embodiment.

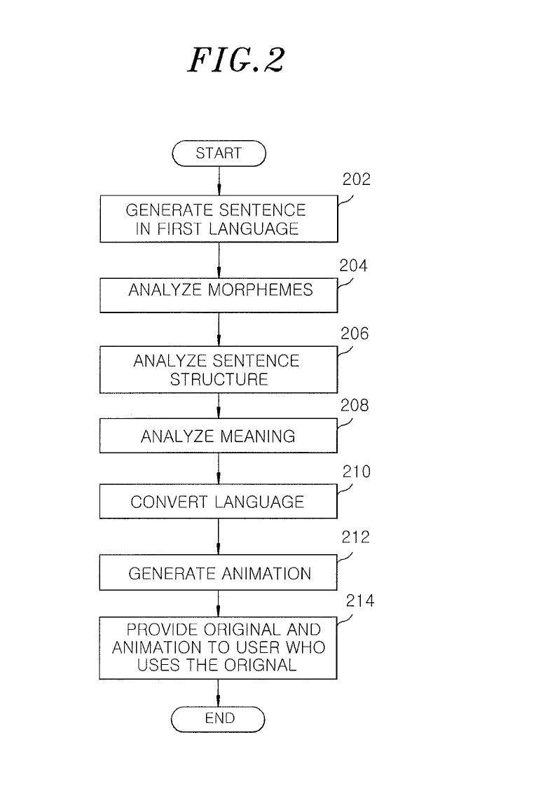

FIG. 2 is a flowchart illustrating major processes for performing translation verification using an animation in accordance with an embodiment of the present invention.

Referring to FIG. 2, when the original (i.e., a first language) in a voice or text form is received from a user who uses the original, the original recognition unit 111 generates a sentence in a first language using the original at step 202. Here, the generated sentence in the first language can be transferred to the interface block 130.

The morpheme analysis unit 112 performs a morpheme analysis of the sentence in the first language generated by the original recognition unit 111 at step 204 and transfers the results of the morpheme analysis to the sentence structure analysis unit 113 and the animation generation block 120.

The sentence structure analysis unit 113 performs a sentence structure analysis of each word based on information on a part of speech whose morpheme has been analyzed by the morpheme analysis unit 112 at step 206 and transfers the results of the sentence structure analysis to the meaning analysis unit 114 and the animation generation block 120.

The meaning analysis unit 114 performs a meaning analysis of each word based on the results of the sentence structure analysis received from the sentence structure analysis unit 113 at step 208 and transfers the results of the meaning analysis to the language conversion unit 115 and the animation generation block 120.

In response thereto, the language conversion unit 115 converts the sentence in the first language (e.g., a native language sentence) into a second language (e.g., a foreign language) based on the results of the meaning analysis received from the meaning analysis unit 114 at step 210 and transfers information on the conversion into the second language to the animation generation block 120.

The animation generation block 120 generates an animation capable of representing the meaning of the sentence in the first language (i.e., the translated language) based on one or more of pieces of information on the results of the analysis of the sentence in the first language (i.e., the original), for example, information on the results of the morpheme analysis of the sentence in the first language, information on the results of the sentence structure analysis of the sentence in the first language, information on the results of the meaning analysis of the sentence in the first language, and the information on the conversion into the second language at step 212 and transfers the generated animation to the interface block 130. The generated animation can be any of, for example, a moving image, a plurality of serial still images, and a still image.

As a result, the interface block 130 gathers (or composes) the original (i.e., the sentence in the first language) received from the translation engine block 110 and the animation (i.e., an animation capable of representing the meaning of the sentence in the first language) received from the animation generation block 120 and provides the gathered results to the user who uses the original at step 214.

Accordingly, the user who uses the original can verify whether or not errors are present in the translation by checking the original and the animation provided to his or her terminal (i.e., displayed in a display panel). If, as a result of the check, there are errors in the translation, a user interface for correcting the errors (e.g., correcting the original and entering the original again) can be performed.

On the one hand, in the translation verification method of the present embodiment, the process of recognizing the original, the process of performing a morpheme analysis, the process of performing a sentence structure analysis, the process of performing a meaning analysis, and the process of performing language translation in order to analyze the original for the sentence in the first language have been illustrated as being sequentially performed, but the invention of the present embodiment is not limited thereto. In some embodiments, the process of recognizing the original, the process of performing a morpheme analysis, and the process of performing language conversion can be performed depending on the translation method that is applied to the translation engine block 110.

On the other hand, in the translation verification apparatus and method of the present embodiment, translation errors that may occur when translating the original have been illustrated as being verified using the animation scheme, but the present invention is not limited thereto. In an embodiment, translation errors can be verified by applying the animation scheme to back translation for verifying the translation errors.

### Embodiment 2

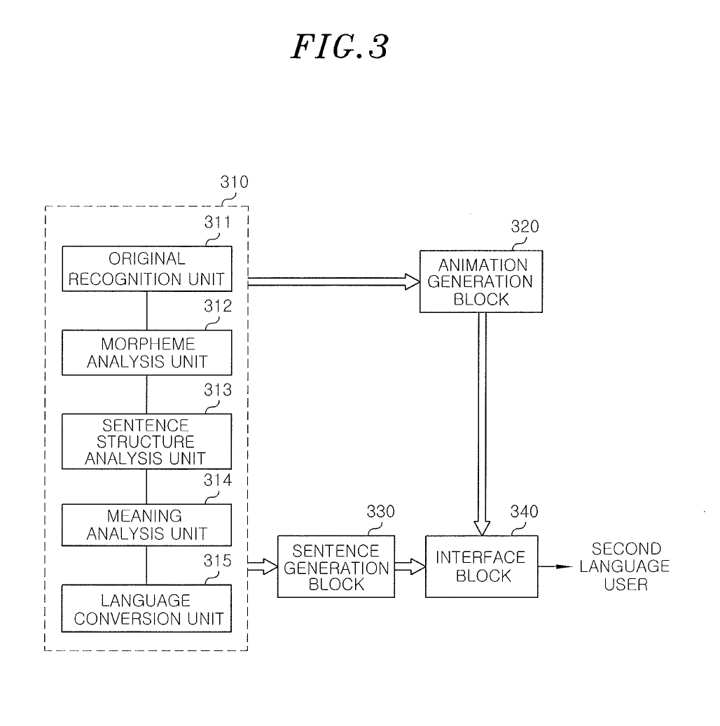

FIG. 3 is a block diagram showing the construction of a translation verification apparatus using an animation in accordance with another embodiment of the present invention. The translation verification apparatus of the present embodiment can basically include a translation engine block 310, an animation generation block 320, a sentence generation block 330, and an interface block 340. The translation engine block 310 can include an original recognition unit 311, a morpheme analysis unit 312, a sentence structure analysis unit 313, a meaning analysis unit 314, and a language conversion unit 315.

Referring to FIG. 3, the translation engine block 310 and the animation generation block 320 have substantially the same constructions and functions as the translation engine block 110 and the animation generation block 120 of FIG. 1. A detailed description of the constructions and functions of the translation engine block 310 and the animation generation block 320 is omitted in order to avoid redundancy.

Unlike the language conversion unit 115, the language conversion unit 315 converts a sentence in a first language (e.g., a native language sentence) into a second language (e.g., a foreign language), transfers the converted second language to the sentence generation block 330, and transfers information on the converted second language to the animation generation block 320.

First, the sentence generation block 330 can perform a function of generating (or converting) a sentence in a first language, received from the language conversion unit 315 of the translation engine block 310, into a sentence in a second language (i.e., a translated sentence) and transferring** the generated sentence in the second language to the interface block 340. Here, the sentence generation block 330 may further include a voice/text generation unit (not shown) for generating voice and text in the second language using the sentence in the second language and transferring the generated voice and text in the second language to the interface block 340.

Accordingly, the interface block 340 can perform a function of gathering (or composing) the sentence in the second language received from the sentence generation block 330 and a corresponding animation (i.e., an animation capable of representing the meaning of the sentence in the first language) received from the animation generation block 320 and transferring the gathered results to a user who uses the second language (e.g., the terminal of the user who uses the translated sentence) so that the user who uses the second language can check for errors in the translation. Here, the sentence in the second language transferred to the user who uses the second language can include information on the second language voice and text.

On the one hand, in the translation verification apparatus of the present embodiment, the translation engine block 310 has been illustrated as including the original recognition unit 311, the morpheme analysis unit 312, the sentence structure analysis unit 313, the meaning analysis unit 314, and the language conversion unit 315, but the invention of the present embodiment is not limited thereto. As in the embodiment 1, the translation engine block 310 applied to the present embodiment may be configured to include only the original recognition unit 311, the morpheme analysis unit 312, and the language conversion unit 315, depending on the translation method.

In a modified embodiment, the translation verification apparatus of the present embodiment may be configured to provide the original (i.e., a sentence in a first language) and a corresponding animation to a user who uses the original and a translated sentence (i.e., a sentence in a second language) and a corresponding animation to a user who uses the second language at the same time so that the users who use the original and the translated sentence can check for translation errors. To this end, the interface block 340 provides the original and the animation to the user who uses the original and the sentence in the second language and the animation to the user who uses the second language at the same time.

A series of processes for performing translation verification using an animation generated using the results of analysis of the original are described in detail below in connection with the translation verification apparatus of the present embodiment.

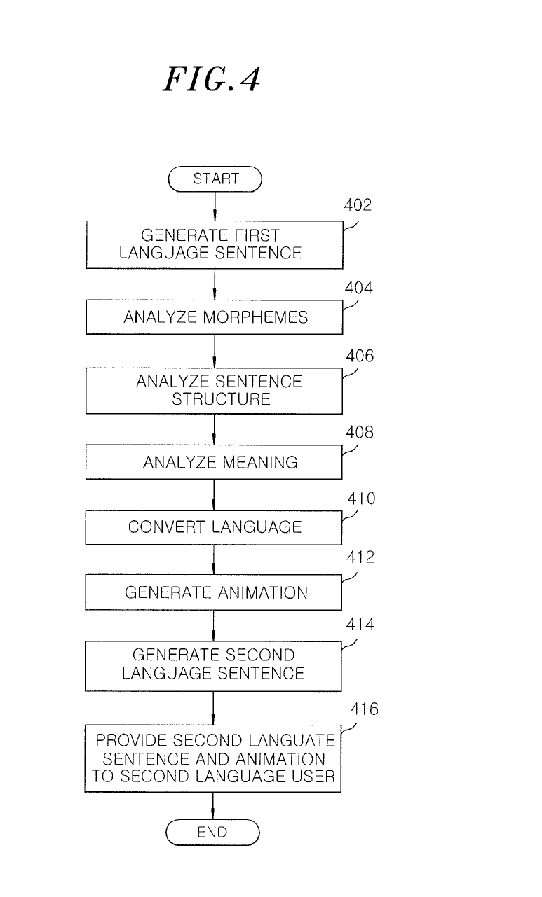

FIG. 4 is a flowchart illustrating major processes for performing translation verification using an animation in accordance with another embodiment of the present invention.

Referring to FIG. 4, processes at steps 402 to 412 are substantially the same as those as steps 202 to 212 of FIG. 2, except that the language conversion unit 315 converts a sentence in a first language into a second language and transfers the converted second language to the sentence generation block 330.

In order to avoid redundant description, a detailed description of the processes at steps 402 to 412 is omitted.

First, the language conversion unit 315 converts a sentence in a first language into a second language and transfers the converted second language to the sentence generation block 330. The sentence generation block 330 converts the received second language into a sentence in a second language (i.e., a translated sentence) and transfers the converted second language sentence to the interface block 340 at step 414. Here, the sentence in the second language can include second language voice and text.

In response thereto, the interface block 340 gathers (or composes) the sentence in the second language received from the language conversion unit 315 of the translation engine block 310 and a corresponding animation (i.e., an animation capable of representing the meaning of the sentence in the first language) received from the animation generation block 320 and provides the gathered results to a user who uses the second language (i.e., a user who uses a translated sentence) at step 416.

Accordingly, the user who uses the translated sentence can check whether or not errors are present in the translation by checking the translated sentence and the animation provided to his or her terminal (i.e., displayed in a display panel). If, as a result of the check, there are errors in the translation, a user operation of correcting the errors (e.g., providing information to the user who uses the original) can be performed.

Meanwhile, in the translation verification method of the present embodiment, the process of recognizing the original, the process of performing a morpheme analysis, the process of performing a sentence structure analysis, the process of performing a meaning analysis, and the process of performing language conversion in order to analyze the original for the sentence in the first language have been illustrated as being sequentially performed, but the invention of the present embodiment is not limited thereto. As in the embodiment 1, the process of recognizing the original, the process of performing a morpheme analysis, and the process of performing language conversion can be performed depending on the translation method applied to the translation engine block 310.

In a modified embodiment, the translation verification method of the present embodiment may be configured to provide the original (i.e., a sentence in a first language) and a corresponding animation to a user who uses the original and a translated sentence (i.e., a sentence in a second language) and a corresponding animation to a user who uses the second language at the same time so that the users who use the original and the translated sentence can check for translation errors. To this end, at step 416, the original and the animation are provided to the user who uses the original, and the sentence in the second language and the animation are provided to the user who uses the second language at the same time.

Furthermore, in the translation verification apparatus and method of the present embodiment, translation errors that may occur when translating the original have been illustrated as being verified using the animation scheme, but the present invention is not limited thereto. As in the embodiment 1, translation errors can be verified by applying the animation scheme to back translation for checking for translation errors.

Detailed contents of the operation of the translation verification apparatus in accordance with the present invention are described below by analyzing an example; the original, translation results, and back translation results.

The original: He requested an apology.

Translation results: [symbol] [symbol] .

Back translation results: He requested an apple.

From the above example, it can be seen that both the original and the translated sentence are normal, but an error occurred in the back translation results. Accordingly, a problem arises if a user who uses the original determines that the error occurred based on the back translation results.

That is, FIG. 5a shows the results of a morpheme analysis of the original (i.e., a sentence in a first language), FIG. 5b shows the results of a sentence structure analysis of the sentence in the first language, FIG. 5c shows the results of a meaning analysis of the sentence in the first language, and FIG. 5d shows the results of the conversion into the second language.

If an animation is configured using the results of the analysis of the original and the configured animation is shared, there is no misunderstanding of the original.

FIG. 6a shows an example in which the above analysis results are configured in the form of an animation (i.e., an animation capable of representing the meaning of the sentence in the first language). A user who uses the original (or a user who uses a translated sentence) will understand that there are no errors in the translation by checking the original and a corresponding animation, such as that shown in FIG. 6a.

FIG. 6b shows another example in which the above analysis results are configured in the form of an animation (i.e., an animation capable of representing the meaning of the sentence in the first language). A user who uses the original (i.e., a user who uses a translated sentence) will understand that there are errors in the translation by checking the original and a corresponding animation, such as that shown in FIG. 6b.

Assuming that a translated sentence (i.e., a sentence in a second language) and an animation for the original are provided to a user who uses the second language (i.e., a user who uses a translated sentence), if the translated sentence and the animation, such as that shown in FIG. 6a, are provided, the user who uses the translated sentence will understand that there are no errors in the translation by checking the animation. If the translated sentence and the animation, such as that shown in FIG. 6b, are provided, the user who uses the translated sentence will understand that there are errors in the translation by checking the animation.

Detailed contents of the operation of the translation verification apparatus in accordance with the present invention are described below by analyzing another example; the original, translation results, and back translation results.

The original: [symbol] [symbol] .

Translation results: I bought a tree and peeled a pear.

Back translation results: [symbol] [symbol] .

FIG. 7a shows the results of a morpheme analysis of the original (i.e., a sentence in a first language), FIG. 7b shows the results of a sentence structure analysis of the sentence in the first language, FIG. 7c shows the results of a meaning analysis of the sentence in the first language, and FIG. 7d shows the results of conversion into a second language.

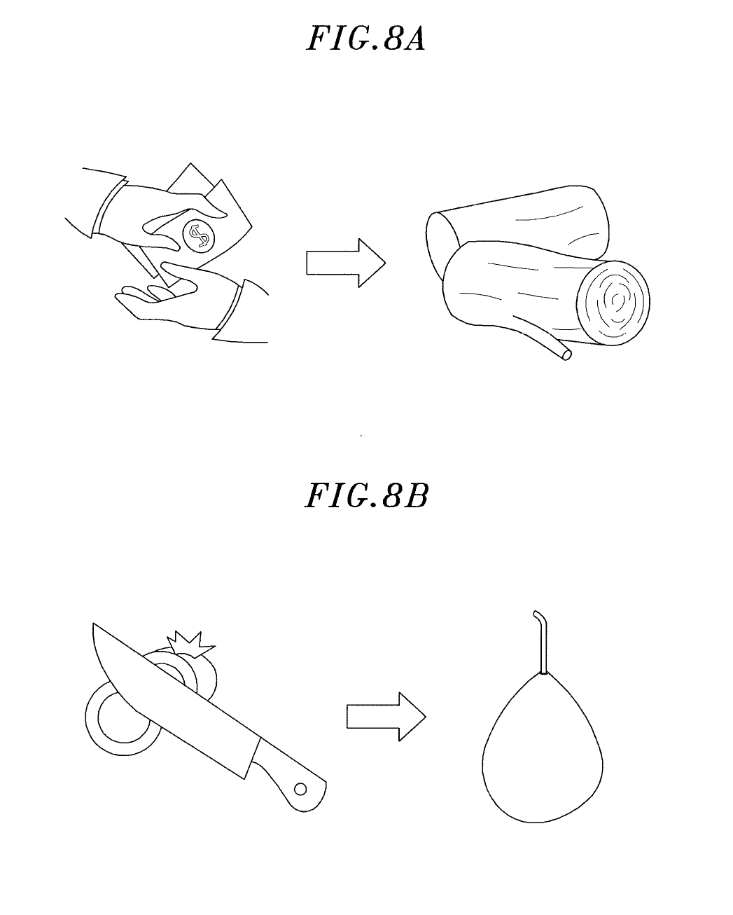

FIGS. 8a and 8b show an example in which the above analysis results are configured in the form of an animation (i.e., an animation capable of representing the meaning of the sentence in the first language). If the original (or the translated sentence) and animations shown in FIGS. 8a and 8b are provided, the user who uses the original (or a user who uses the translated sentence) will understand that there are errors in the translation by checking the original and the animation, such as that shown in FIG. 8b.

FIGS. 9a and 9b show another example in which the above analysis results are configured in the form of an animation (i.e., an animation capable of representing the meaning of the sentence in the first language). If the original (or the translated sentence) and animations shown in FIGS. 9a and 9b are provided, a user who uses the original (or a user who uses the translated sentence) will understand that there are no errors in the translation by checking the original and an animation, such as that shown in FIG. 9b.

In accordance with the present invention, in order to verify the accuracy of a translated sentence, that is, the results of automatic translation, an animation corresponding to the results of an analysis of the original (i.e., a first language) is selectively provided to a first user or a second user. Accordingly, problems occurring in verifying translation errors can be effectively solved.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A translation verification method using an animation, comprising processes of:
analyzing an original in a first language using a translation engine so that the sentence in the first language is converted into a second language;
generating an animation capable of representing a meaning of the sentence in the first language based on information on results of the analyzing the sentence in the first language; and
providing the original and the generated animation to a user who uses the original in order for the user to check for errors in the translation.

2. The translation verification method of claim 1, wherein the information on the results of the analyzing comprises one or more of information on results of a morpheme analysis of the sentence in the first language, information on results of a sentence structure analysis of the sentence in the first language, information on results of a meaning analysis of the sentence in the first language, and information on conversion into the second language.

3. The translation verification method of claim 1, wherein the process of analyzing a sentence in a first language comprises processes of:
receiving the original and generating the sentence in the first language;
performing a morpheme analysis of the generated sentence in the first language;
performing a sentence structure analysis of each word based on information on a part of speech whose morpheme has been analyzed;
performing a meaning analysis of each word based on results of the sentence structure analysis; and
converting the sentence in the first language into the second language based on results of the meaning analysis.

4. The translation verification method of claim 1, wherein the process of analyzing a sentence in a first language comprises processes of:
receiving the original and generating the sentence in the first language;
performing a morpheme analysis of the generated sentence in the first language; and
converting the sentence in the first language into the second language based on results of the morpheme analysis.

5. A translation verification apparatus using an animation, comprising:
a translation engine block for analyzing an originally input sentence in a first language so that the sentence in the first language is converted into a second language;
an animation generation block for generating an animation capable of representing a meaning of the sentence in the first language based on information on results of the analysis of the sentence in the first language; and
an interface block for providing the original and the generated animation to a user who uses the original in order for the user to check for errors in the translation.

6. The translation verification apparatus of claim 5, wherein the animation generation block generates the animation using one or more of information on results of a morpheme analysis of the sentence in the first language, information on results of a sentence structure analysis of the sentence in the first language, information on results of a meaning analysis of the sentence in the first language, and information on the conversion into the second language.

7. The translation verification apparatus of claim 5, wherein the translation engine block comprises:
an original recognition unit for receiving the original and generating the sentence in the first language;
a morpheme analysis unit for performing a morpheme analysis of the generated sentence in the first language;
a sentence structure analysis unit for performing a sentence structure analysis of each word based on information on a part of speech whose morphemes have been analyzed;
a meaning analysis unit for performing a meaning analysis of each word based on results of the sentence structure analysis; and
a language conversion unit for converting the sentence in the first language into the second language based on results of the meaning analysis.

8. The translation verification apparatus of claim 5, wherein the translation engine block comprises:
an original recognition unit for receiving the original and generating the sentence in the first language;
a morpheme analysis unit for performing a morpheme analysis of the generated sentence in the first language; and
a language conversion unit for converting the sentence in the first language into the second language based on results of the morpheme analysis.

9. A translation verification method using an animation, comprising processes of:
analyzing an original in a first language using a translation engine so that the sentence in the first language is converted into a second language;
generating an animation capable of representing a meaning of the sentence in the first language based on information on results of the analyzing the original in the first language; and
providing a sentence in a second language and an animation generated by analyzing the sentence in the first language to a user who uses the sentence in the second language in order for the user to check for errors in the translation.

10. The translation verification method of claim 9, wherein the information on results of the analysis comprises one or more of information on results of a morpheme analysis of the sentence in the first language, information on results of a sentence structure analysis of the sentence in the first language, information on results of a meaning analysis of the sentence in the first language, and information on the conversion into the second language.

11. The translation verification method of claim 9, wherein the process of analyzing a sentence in a first language comprises processes of:
receiving the original and generating the sentence in the first language;
performing a morpheme analysis of the generated sentence in the first language;
performing a sentence structure analysis of each word based on information on a part of speech whose morpheme has been analyzed;
performing a meaning analysis of each word based on results of the sentence structure analysis; and
converting the sentence in the first language into the second language based on results of the meaning analysis.

12. The translation verification method of claim 9, wherein the process of analyzing a sentence in a first language comprises processes of:
receiving the original and generating the sentence in the first language;
performing a morpheme analysis of the generated sentence in the first language; and
converting the sentence in the first language into the second language based on results of the morpheme analysis.

13. The translation verification method of claim 9, wherein the sentence in the second language comprises second language voice and text corresponding to the sentence in the second language.
